(19) United States
(12) Patent Application Publication
(10) Pub. No.: US 2026/0158625 A1
(43) Pub. Date: Jun. 11, 2026

(54) RATCHET MECHANISM FOR RATCHET WRENCHES

(71) Applicants: Yi-Fu Chen, Taichung City (TW); He-Qian Chen, Taichung City (TW)

(72) Inventors: Yi-Fu Chen, Taichung City (TW); He-Qian Chen, Taichung City (TW)

(21) Appl. No.: 18/970,918

(22) Filed: Dec. 6, 2024

(51) Int. Cl. B25B 13/46

(52) U.S. Cl. CPC B25B 13/463

(57) ABSTRACT

A ratchet wrench includes a wrench head with a ratchet space and a hole which communicates with the ratchet space. The ratchet space accommodates a ratchet-pawl assembly. The hole accommodates a direction-switching device. The ratchet-pawl assembly includes a ratchet and first and second pawls. The first and second pawls have pawl teeth on the first side thereof, and recessed areas on the second side thereof. Both ends of the first and second pawls have arc portions. The first and second pawls form abutting portions with thicknesses at two ends of the first side thereof. The thickness of the abutting portions of the first pawl is greater than the thickness of the abutting portions of the second pawl. The direction-switching device includes a toggle member which has first and second beads respectively pushed by first and second springs so as to be engaged with the first and second recessed areas.

### BACKGROUND OF THE INVENTION

1. Fields of the invention
The present invention relates to an application in hand-operated wrench tools, and more particularly, to a ratchet mechanism, particularly for use in rotating ratchet wrenches, and represents a highly practical invention.
2. Descriptions of Related Art

As shown in FIGS. 8, 9, and 10, this is a known reversible ratchet wrench, with a structure that mainly includes a ratchet 2 and a pawl block 3 set inside the wrench head 1, and a switching unit 4 used to control the pawl block 3. The switching unit 4 consists of a toggle member 5, and a spring 6 and a linking member 7 installed within the toggle member 5. The linking member 7 protrudes outside the toggle member 5 under the spring force of the spring 6 and extends into the recessed area 8 of the pawl block 3. Through the left and right toggling of the toggle member 5, the direction and position of the linking member 7 and pawl block 3 correspondingly change, thereby changing the rotation direction of the ratchet 2.

The above known example has the following problems:
When the toggle member 5 is switched to change position, the linking member 7 pushes along the recessed area of the pawl block 3. At this time, because the two side portions 31 of the pawl block 3 and the action wall 9 of the wrench head 1 are in linear plane contact, it causes tight pressing of the pawl block 3 and the action wall 11 without clearance easily. Therefore, during use, it can easily cause unsmooth disengagement and repositioning of the pawl block 3, giving users a stuck and jerky feeling during operation.

Because the two side portions 31 of the pawl block 3 and the action wall 9 of the wrench head 1 are in linear plane contact, the left and right deflection angle of the linking member 7 tends to be small, only about −26 degrees˜0 degrees˜26 degrees of angular swing. This prevents achieving the maximum stopping effect between the pawl block 3 and the ratchet 2, thus resulting in insufficient maximum torque that can be achieved during use.

Since the peripheral ratchet teeth 21 of the ratchet 2 in this type of ratchet wrench design are paired with a single linking member 7, there is a limitation on the number of ratchet teeth 21. Therefore, the common number of the ratchet teeth is mostly between 60-72 teeth, which means the necessary swing angle of the wrench is 5-6 degrees. However, as technology advances, items are becoming smaller and various device installations are becoming more crowded, there is an increasing demand for ratchet wrenches with even smaller necessary swing angles. If one wants to reduce the swing angle, the number of gear teeth must be increased. However, increasing the number of teeth without changing the ratchet size would reduce the force that the teeth can withstand. If the ratchet size is increased, it would result in the wrench being unable to work in narrow spaces. How to develop a way to further reduce the necessary swing angle of the ratchet wrench without changing the ratchet size and number of ratchet teeth is a critical problem that needs to be solved today.

The present invention intends to provide a ratchet mechanism to eliminate the shortcomings mentioned above.

### SUMMARY OF THE INVENTION

The present invention relates to a ratchet wrench and comprises a wrench head having a ratchet space and a hole. A recess is formed in an inner periphery of the ratchet space and communicates with the hole in the wrench head. A ratchet-pawl assembly is accommodated in the ratchet space, and a direction-switching device is installed in the hole.

The ratchet-pawl assembly includes a ratchet and first and second pawls. The ratchet has ratchet teeth formed in an outer periphery of the ratchet. The first pawl has first pawl teeth formed on a first side thereof facing the ratchet teeth. The second pawl has second pawl teeth formed on a first side thereof facing the ratchet teeth. A first recessed area is formed on a second side of the first pawl and faces away from the ratchet teeth. A second recessed area is formed on a second side of the second pawl and faces away from the ratchet teeth. The first pawl has two first arc portions formed on two ends thereof and located corresponding to a shape of the recess. The second pawl has two second arc portions formed on two ends thereof and located corresponding to the shape of the recess.

The first pawl has two first abutting portions with a thicknesses at two ends of the first side thereof. The second pawl has two second abutting portions with a thicknesses at two ends of the first side thereof. The thickness of the first abutting portions of the first pawl is greater than the thickness of the abutting portions of the second pawl. A fixing member secures the ratchet-pawl assembly within the ratchet space of the wrench head.

The direction-switching device includes a toggle member, and first and second cavities are defined in the toggle member. The first and second cavities are respectively located corresponding to the first and second pawls. A first bead and a first spring are accommodated in the first cavity. A second bead and a second spring are accommodated in the second cavity. The first bead is pushed by the first spring so that the first bead is engaged with the first recessed area. The second bead is pushed by the second spring so that the second bead is engaged with the second recessed area.

The main purpose of the present invention is to provide a ratchet mechanism with a smaller tooth engagement angle, offering better spatial convenience during use, while achieving improved structural stability and easy assembly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded perspective view of the ratchet wrench of the present invention;

FIG. 2 is a perspective view of the ratchet wrench of the present invention;

FIG. 3 is a longitudinal sectional view of the ratchet wrench of the present invention;

FIG. 4 is a first transverse sectional view and operational diagram showing the ratchet wrench of the present invention in action;

FIG. 5 is a second transverse sectional view and operational diagram showing the ratchet wrench of the present invention in action;

FIG. 6 is a first transverse sectional view and operational diagram showing the ratchet wrench of the present invention in action from the opposite side;

FIG. 7 is a second transverse sectional view and operational diagram showing the ratchet wrench of the present invention in action from the opposite side;

FIG. 8 is a first sectional view and operational diagram of a conventional reversible ratchet wrench;

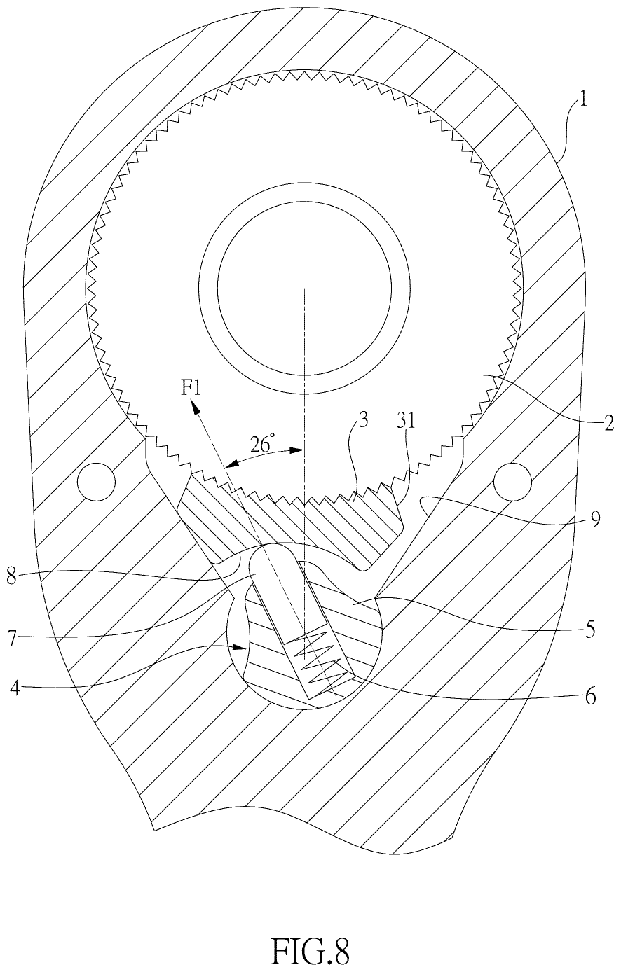

FIG. 9 is a second sectional view and operational diagram of a conventional reversible ratchet wrench, and

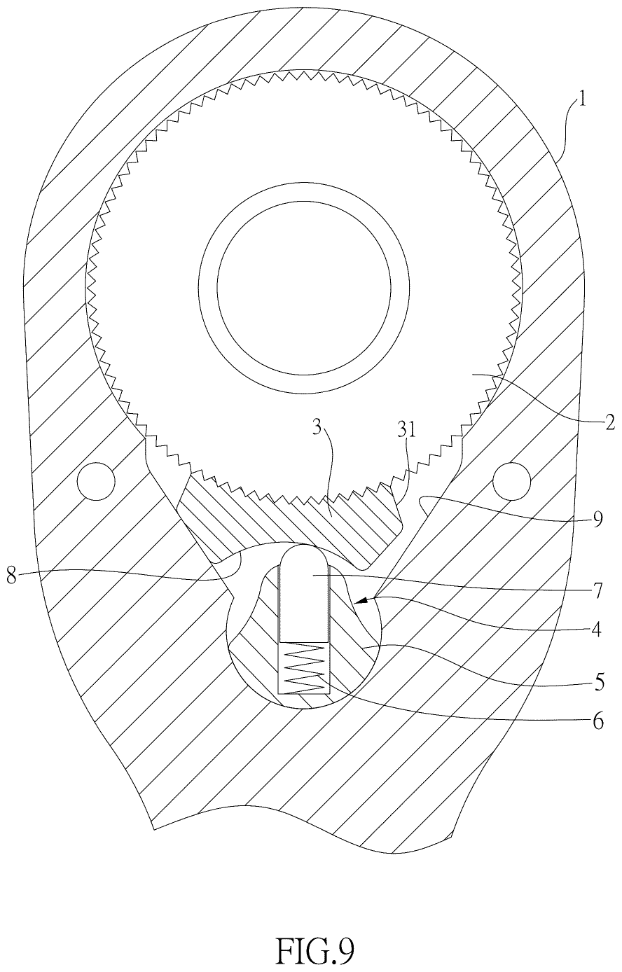

FIG. 10 is a third sectional view and operational diagram of a conventional reversible ratchet wrench.

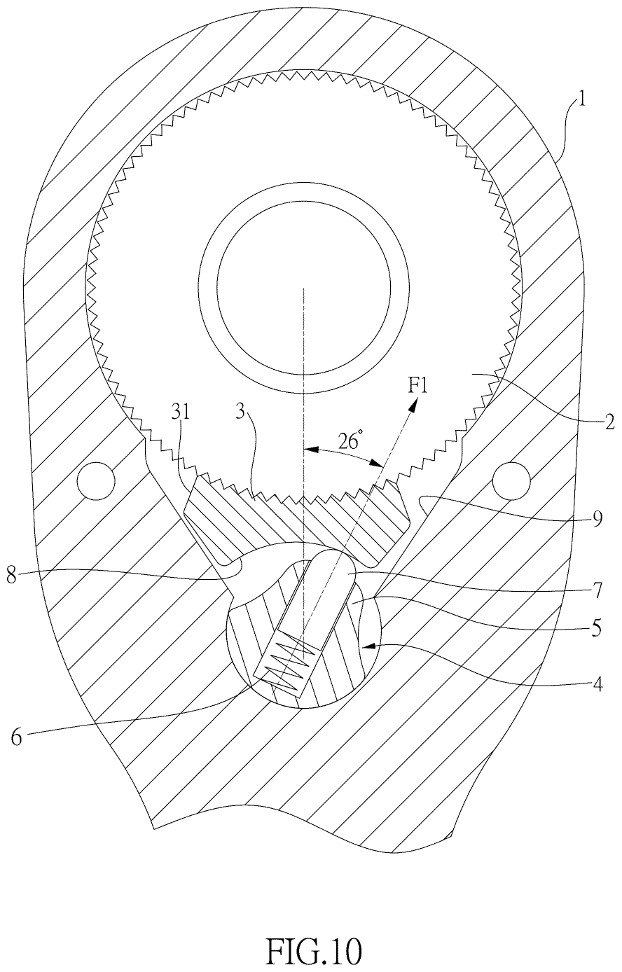

### DETAILED DESCRIPTION OF THE PREFERRED EMBODIMENT

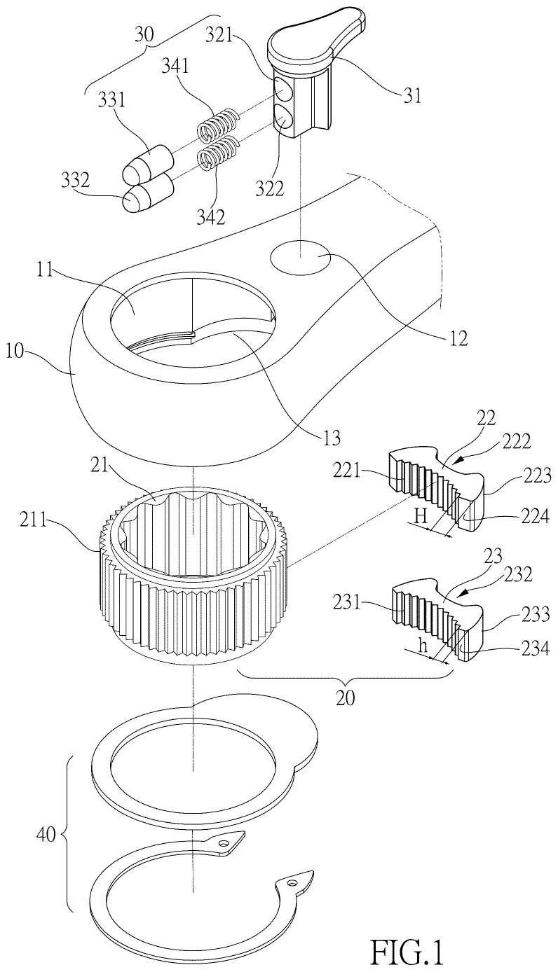

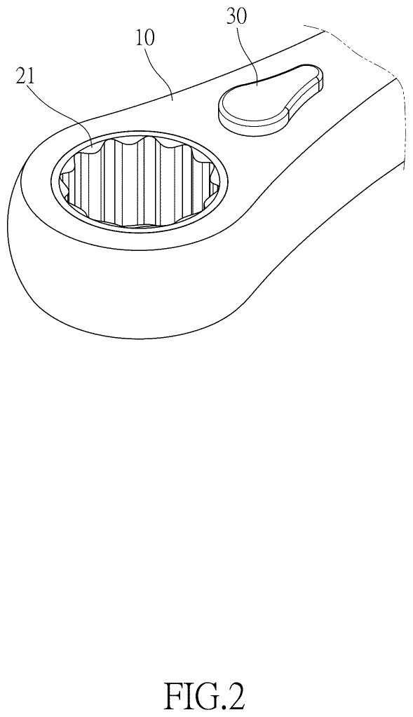

Referring to FIGS. 1 to 7, the ratchet wrench of the present invention comprises a wrench head (10) having a ratchet space (11) and a hole (12). A recess (13) is formed in an inner periphery of the ratchet space (11) and communicates with the hole (12) in the wrench head (11). A ratchet-pawl assembly (20) is accommodated in the ratchet space (11), and a direction-switching device (30) is installed in the hole (12).

The ratchet-pawl assembly (20) includes a ratchet (21) and first and second pawls (22, 23). The ratchet (21) has ratchet teeth (211) formed in an outer periphery of the ratchet (21). The first pawl (22) has first pawl teeth (221) formed on a first side thereof facing the ratchet teeth (211). The second pawl (23) has second pawl teeth (231) formed on a first side thereof facing the ratchet teeth (211). A first recessed area (222) is formed on a second side of the first pawl (22) and faces away from the ratchet teeth (211). A second recessed area (232) is formed on a second side of the second pawl (23) and faces away from the ratchet teeth (211). The first pawl (22) has two first arc portions (223) formed on two ends thereof and located corresponding to a shape of the recess (13). The second pawl (23) has two second arc portions (233) formed on two ends thereof and located corresponding to the shape of the recess (13).

The first pawl (22) has two first abutting portions (224) with a thicknesses (H) at two ends of the first side thereof. The second pawl (23) has two second abutting portions (234) with a thicknesses (h) at two ends of the first side thereof. The thickness (H) of the first abutting portions (224) of the first pawl (22) is greater than the thickness (h) of the second abutting portions (234) of the second pawl (23). A fixing member (40) secures the ratchet-pawl assembly (20) within the ratchet space (11) of the wrench head (10).

The direction-switching device (30) includes a toggle member (31), and first and second cavities (321, 322) are defined in the toggle member (31. The first and second cavities (321, 322) are respectively located corresponding to the first and second pawls (22, 23). A first bead (331) and a first spring (341) are accommodated in the first cavity (321). A second bead (332) and a second spring (342) are accommodated in the second cavity (322). The first bead (331) is pushed by the first spring (342) so that the first bead (331) is engaged with the first recessed area (222). The second bead (332) is pushed by the second spring (342) so that the second bead (332) is engaged with the second recessed area (232).

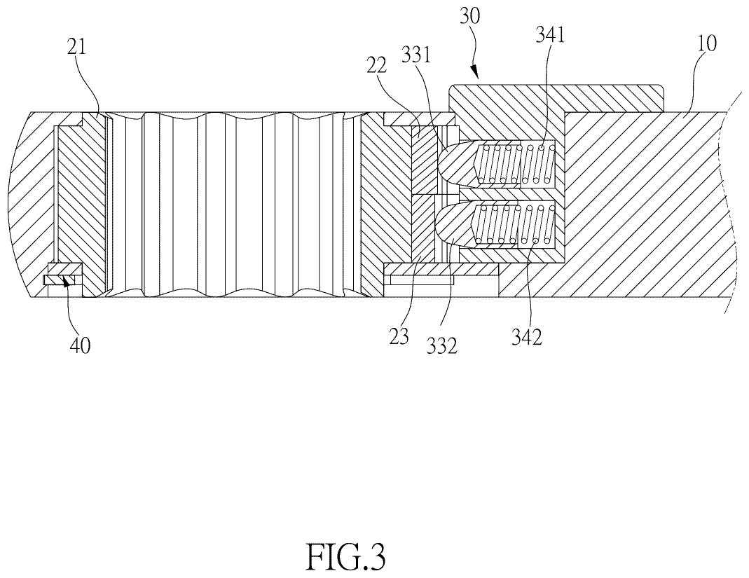

As shown in FIGS. 3 to 5, when assembling the ratchet mechanism, the ratchet-pawl assembly (20) is installed within the through ratchet space (11), allowing the first and second pawl teeth (221, 231) of the first and second pawls (22, 23) to respectively engage with the corresponding ratchet teeth (211). Then, the fixing member (40) is used to secure the ratchet-pawl assembly (20) within the ratchet space (11) of the wrench head (10).

The direction-switching device (30) is fitted into the hole (12) of the wrench head (10), such that the first and second beads (331, 332) housed in the first and second cavities (321, 322) are respectively biased by the first and second springs (341, 342). This causes the first and second beads (331, 332) to engage with the same side of the first and second recessed areas (222, 232) of the first and second pawls (22, 23) respectively.

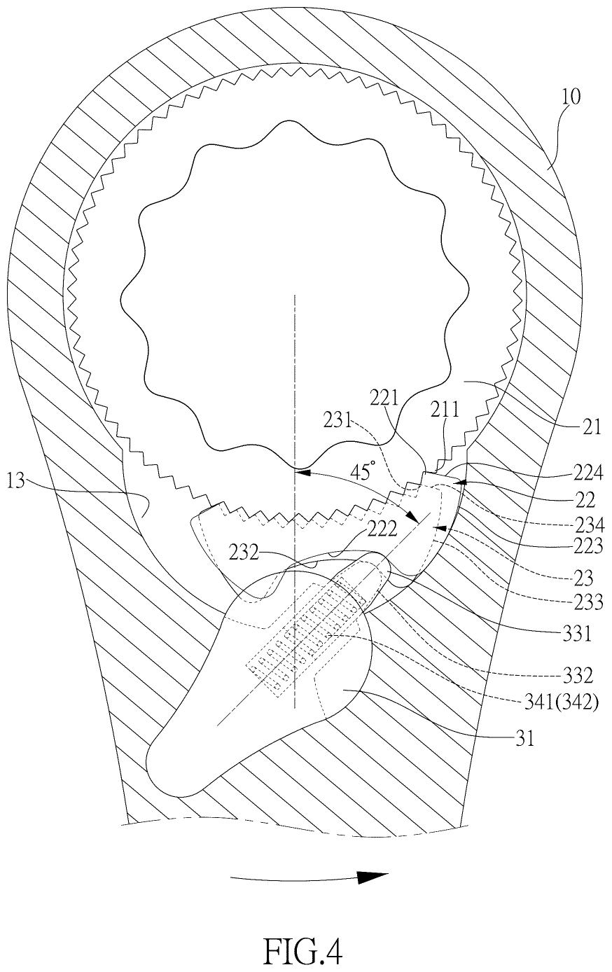

After assembly, when the toggle member (31) is rotated directly to the right side (best shown in FIG. 4), the first and second pawl teeth (221, 231) of both first and second pawls (22, 23) can respectively engage with the corresponding ratchet teeth (211). Since the abutting portions (224) of the first pawl (22) have a greater thickness (H), the first arc portions (223) of the first pawl (22) will engage earlier with the inside wall of the recess (13) of the wrench head (10). This causes the ratchet (21) to be prevented from rotating as the ratchet teeth (211) are blocked by the first abutting portions (224) of the first pawl (22).

When the wrench head (10) is operated and rotates back and forth, the first pawl (22) will rotate leftward to a certain angle due to the reverse rotation of the wrench head (10). At this time, since the abutting portions (234) of the second pawl (23) have a thickness (h) less than the thickness (H), there is space between its arc portions (233) and the recess (13) of the wrench head (10). Therefore, the second pawl (23), while also being acted upon by the second bead (332), will be pushed upward until the arc portions (233) of the second pawl (23) engage with the recess (13).

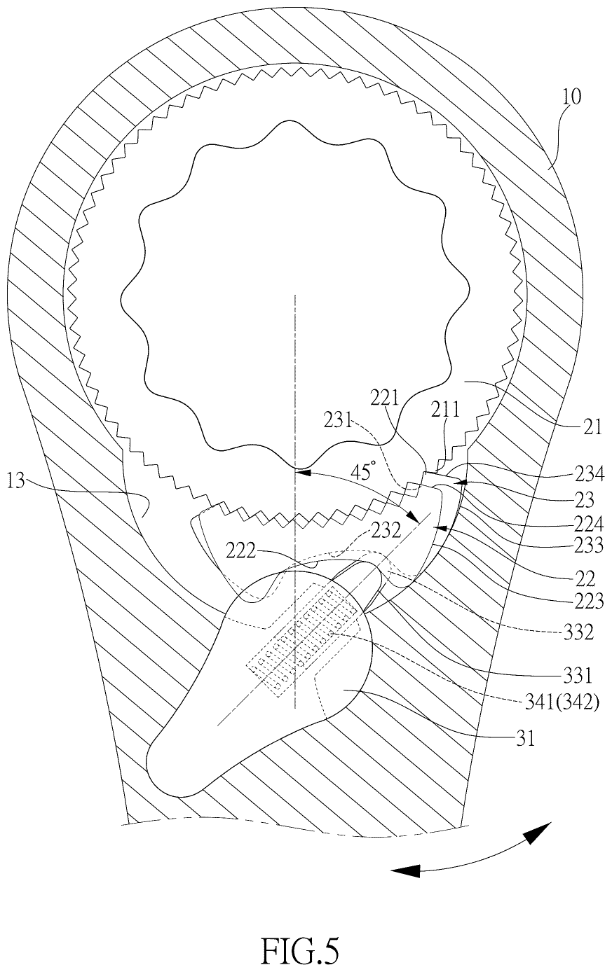

Due to the relationship where thickness (h) is less than thickness (H), when the second pawl (23) engages with the ratchet teeth (211) at this time, the first pawl teeth (221) of the first pawl (22) can only touch the tip positions of the ratchet teeth (211) of the ratchet (21), as best shown in FIG. 5.

Through this structural arrangement, when rotating a workpiece (not shown in the figures), the first and second pawl teeth (221, 231) of the first and second pawls (22, 23) respectively engage with adjacent ratchet teeth (211). Due to the different thicknesses of the first and second abutting portions (224, 234), the first and second pawls (22, 23) are each affected by the first and second beads (331, 332) respectively within the first and second recessed areas (222, 232). This achieves the effect of engaging the workpiece at a small angle, allowing the first and second pawl teeth (221, 231) of the first and second pawls (22, 23) to alternately engage between the valleys of the ratchet teeth (211) and the tip portions of adjacent ratchet teeth (211).

Similarly, when the first and second pawl teeth (221, 231) of the first and second pawls (22, 23) respectively engage with adjacent ratchet teeth (211) of the ratchet (21), due to the different thicknesses of the first and second abutting portions (224, 234), the overall rotation angle of the ratchet teeth (211) of the ratchet-pawl assembly (20) is reduced to half of the original angle. In other words, the original angle between teeth of the ratchet teeth (211) is transformed into a rotatable angle between tooth valley and tooth tip.

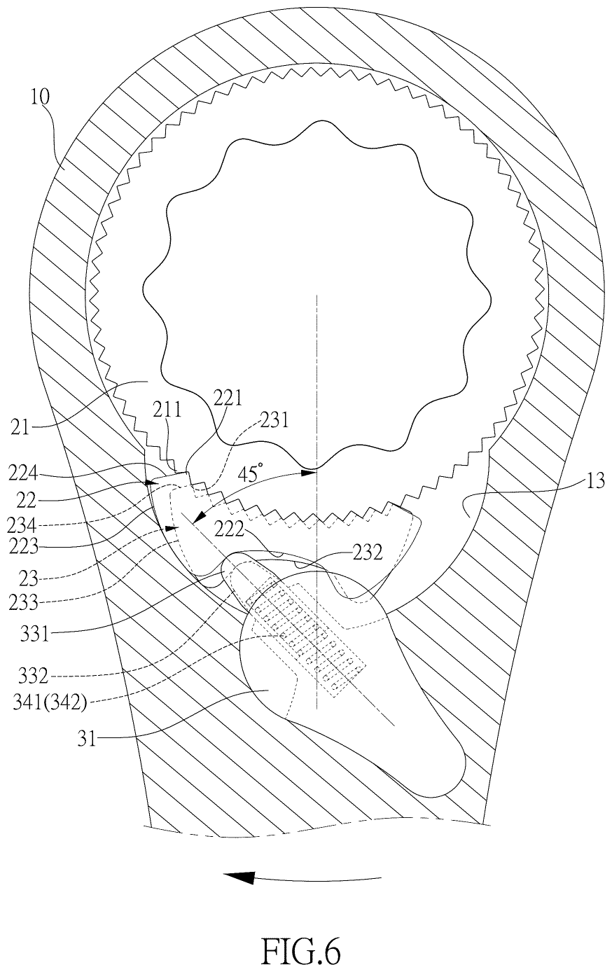

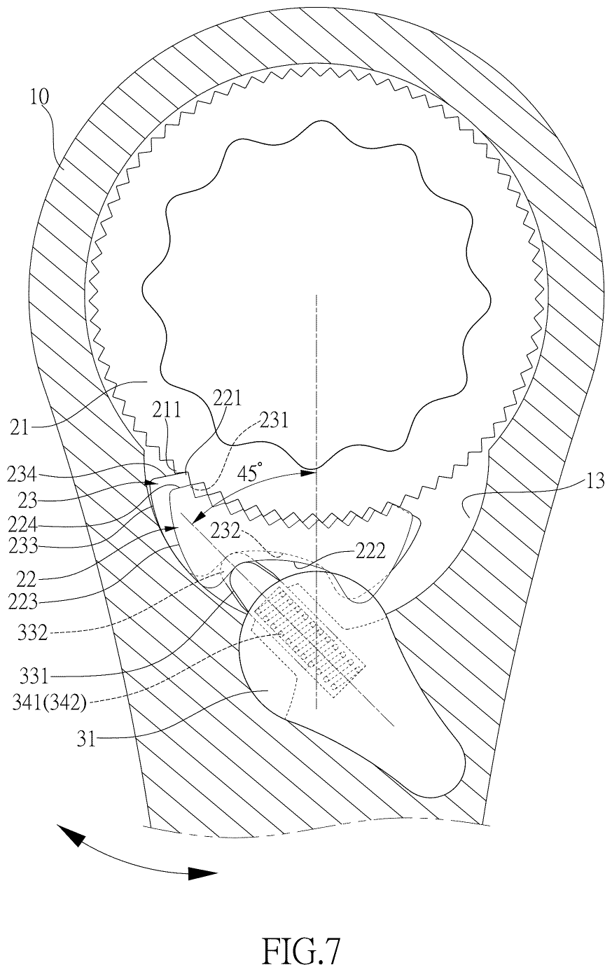

When changing the direction of operation, the user can switch the toggle member (31) to the opposite side (as shown in FIGS. 6 and 7), causing the first and second beads (331, 332) to respectively engage with the opposite sides of the first and second recessed areas (222, 232). Similarly, when the first and second pawl teeth (221, 231) of the first and second pawls (22, 23) respectively engage with the ratchet teeth (211) of the ratchet (21), due to the different thicknesses of the first and second abutting portions (224, 234), the overall rotation angle of the ratchet teeth (211) of the ratchet-pawl assembly (20) is again reduced to half of the original angle.

Furthermore, both ends of the first and second pawls (22, 23) have first and second arc portions (223, 233) that correspond to the shape of the recess (13). Therefore, when the first and second pawls (22, 23) are pushed, the first and second arc portions (223, 233) can engage with the recess (13) through a curved contact surface in an arc-like manner. This can achieve a maximum range of negative 45 degrees −0 degrees—positive 45 degrees expansion, resulting in optimal engagement force.

While we have shown and described the embodiment in accordance with the present invention, it should be clear to those skilled in the art that further embodiments may be made without departing from the scope of the present invention.

What is claimed is:

1. A ratchet wrench comprising:
a wrench head having a ratchet space and a hole, a recess formed in an inner periphery of the ratchet space and communicating with the hole in the wrench head, a ratchet-pawl assembly accommodated in the ratchet space, a direction-switching device installed in the hole;
the ratchet-pawl assembly including a ratchet and first and second pawls, the ratchet having ratchet teeth formed in an outer periphery of the ratchet, the first pawl having first pawl teeth formed on a first side thereof facing the ratchet teeth, the second pawl having second pawl teeth formed on a first side thereof facing the ratchet teeth, a first recessed area formed on a second side of the first pawl and facing away from the ratchet teeth, a second recessed area formed on a second side of the second pawl and facing away from the ratchet teeth, the first pawl having two first arc portions formed on two ends thereof and located corresponding to a shape of the recess, the second pawl having two second arc portions formed on two ends thereof and located corresponding to the shape of the recess;
the first pawl having two first abutting portions with a thicknesses at two ends of the first side thereof, the second pawl having two second abutting portions with a thicknesses at two ends of the first side thereof, the thickness of the first abutting portions of the first pawl being greater than the thickness of the second abutting portions of the second pawl;
a fixing member securing the ratchet-pawl assembly within the ratchet space of the wrench head, and
the direction-switching device including a toggle member, and first and second cavities defined in the toggle member, the first and second cavities respectively located corresponding to the first and second pawls, a first bead and a first spring accommodated in the first cavity, a second bead and a second spring accommodated in the second cavity, the first bead being pushed by the first spring so that the first bead is engaged with the first recessed area, the second bead being pushed by the second spring so that the second bead is engaged with the second recessed area.
